(19) United States
(12) Patent Application Publication
(10) Pub. No.: US 2008/0283204 A1
(43) Pub. Date: Nov. 20, 2008

(54) Door having interconnected upper and lower sashes

(75) Inventors: Richard L. Beck, Strasburg, OH (US); Ryan M. Straits, Sugarcreek, OH (US)

Correspondence Address: SAND & SEBOLT, AEGIS TOWER, SUITE 1100, 4940 MUNSON STREET, NW, CANTON, OH, 44718-3615, US

(73) Assignee: Precision Entry, Inc., Sugarcreek, OH (US)

(21) Appl. No.: 11/901,356

(22) Filed: Sep. 17, 2007

Related U.S. Application Data
(63) Continuation-in-part of application No. 11/803,764, filed on May 16, 2007.

(51) Int. Cl. E06B 3/42; E06B 9/42

(52) U.S. Cl. 160/239; 160/369

(57) ABSTRACT

A door assembly includes a door body, an upper panel slidably mounted on the door body, a lower panel slidably mounted on the door body and an interconnection between the upper and lower panels so that the upper panel may be raised with the lower panel. Preferably, a pair of retractable screens is mounted on the door body and connected respectively to the upper and lower panels.

### CROSS REFERENCE TO RELATED APPLICATION

This application is a Continuation-In-Part of U.S. patent application Ser. No. 11/803,764, filed May 16, 2007; the disclosure of which is incorporated herein by reference.

### BACKGROUND OF THE INVENTION

1. Technical Field

The present invention relates generally to hinged doors. More particularly, the invention relates to such a door having a retractable screen. Specifically, the invention relates to such a door having more than one retractable screen.

2. Background Information

It is known in the art to mount a retractable screen on a door so that the screen is deployable as a window on the door is slid to an open position and retracted as the window is slid to a closed position. However, such doors create only a single screened opening when the window is in the open position, which has limitations especially with respect to airflow through the door. Thus, there is a need in the art for a door having multiple retractable screens.

### BRIEF SUMMARY OF THE INVENTION

A door assembly comprising: a door body; an upper panel mounted on and slidable upwardly and downwardly relative to the door body; a lower panel mounted on and slidable upwardly and downwardly relative to the door body; and an interconnection between the upper and lower panels so that the upper panel is upwardly slidable in response to upward sliding movement of the lower panel.

### BRIEF DESCRIPTION OF THE SEVERAL VIEWS OF THE DRAWINGS

FIG. 1 is a front elevational view of a first embodiment of the door of the present invention with the windows closed.

FIG. 1A is a sectional view taken on line 1A-1A of FIG. 1.

FIG. 2 is a sectional view taken on line 2-2 of FIG. 1.

FIG. 3 is a front elevational view of the door of the first embodiment with the upper window lowered and the upper screen in the deployed position.

FIG. 4 is a sectional view taken on line 4-4 of FIG. 3.

FIG. 5 is a front elevational view of the door of the first embodiment with the lower window raised and the lower screen in the deployed position.

FIG. 6 is a sectional view taken on line 6-6 of FIG. 5.

FIG. 7 is a front elevational view of the first embodiment with both of the windows open and both of the screens deployed.

FIG. 8 is a front elevational view of a second embodiment of the door of the present invention in which the door includes a kick plate or lower panel.

FIG. 9 is a sectional view taken on line 9-9 of FIG. 8.

FIG. 10 is a front elevational view of the door of the second embodiment with the upper window lowered and the upper screen deployed.

FIG. 11 is a front elevational view of the door of the second embodiment with the lower window raised and the lower screen deployed.

FIG. 12 is a sectional view taken on line 12-12 of FIG. 11.

Similar numbers refer to similar parts throughout the drawings.

FIG. 13 is a front elevational view of the door of the first embodiment which is similar to FIG. 3 except that the upper panel or window is lowered to a fully lowered or fully opened position with the upper screen in a fully deployed position.

FIG. 14 is a sectional view taken on line 14-14 of FIG. 13.

FIG. 15 is an enlarged sectional view of a portion of FIG. 14 showing the lower ends of the upper and lower panels and the lower screen in a fully retracted position.

FIG. 16 is similar to FIG. 15 and shows the lower panel being manually raised to simultaneously raise the upper panel via the interconnection therebetween.

FIG. 17 is similar to FIG. 14 and shows the upper and lower panels in their fully raised positions with the lower screen fully deployed.

FIG. 18 is similar to FIG. 17 and shows the lower panel having moved downwardly to its fully lowered position.

FIG. 19 is an enlarged sectional view of the encircled portion of FIG. 18.

### DETAILED DESCRIPTION OF THE INVENTION

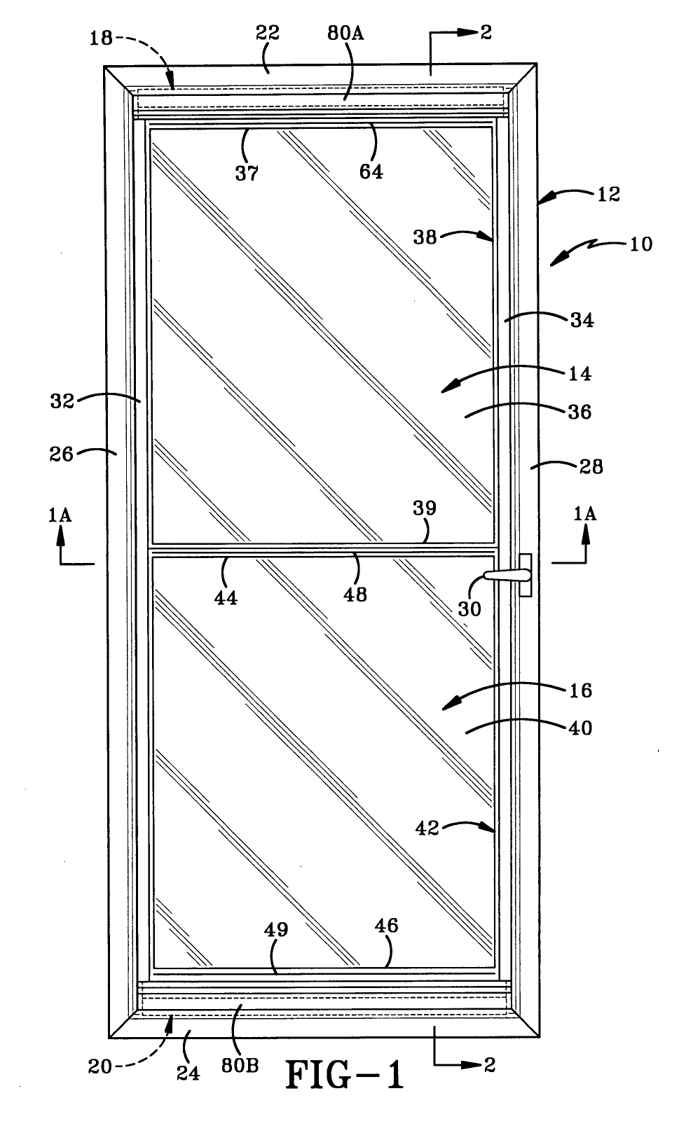

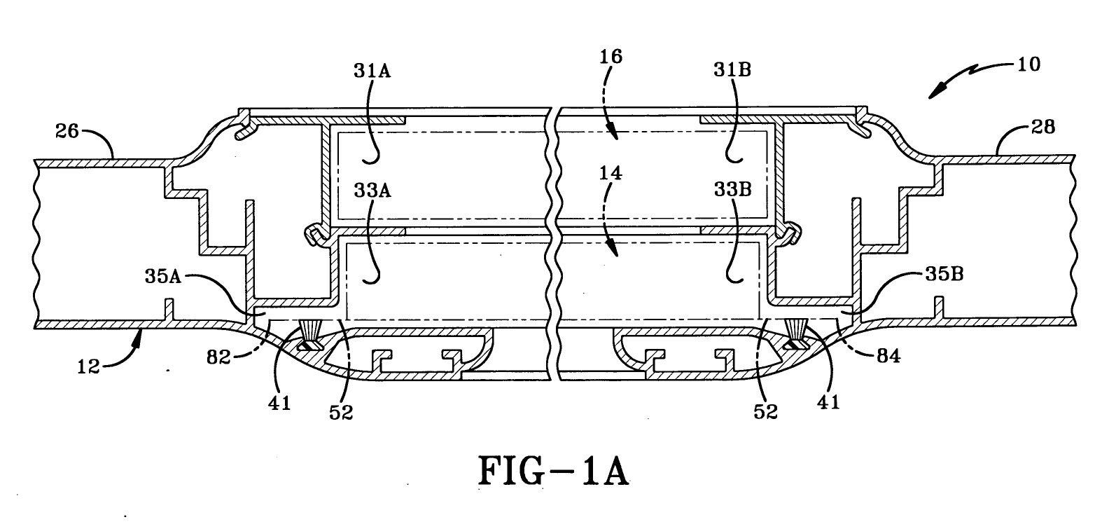

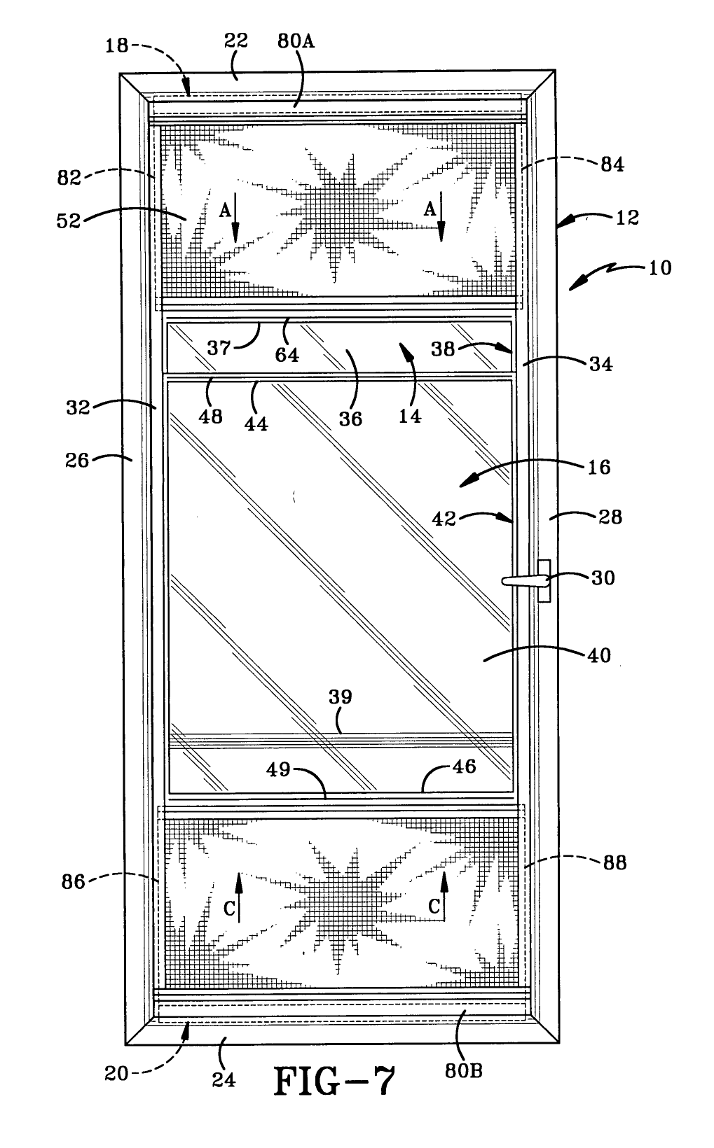

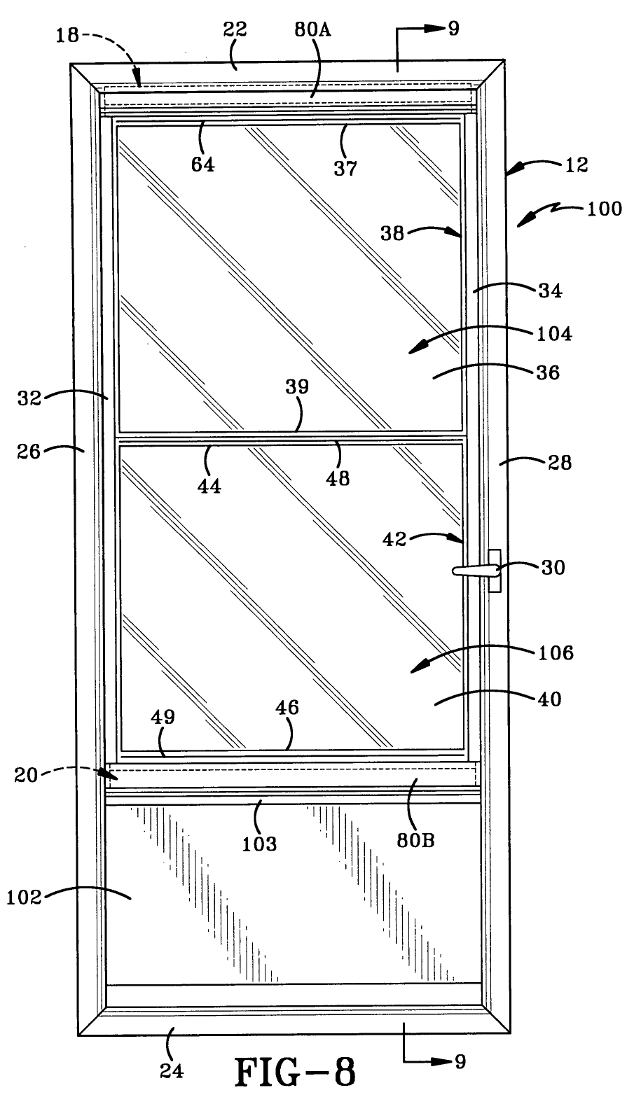

A first embodiment of the door of the present invention is indicated generally at 10 in FIG. 1; and a second embodiment is indicated generally at 100 in FIG. 8. Referring to FIG. 1, door 10 includes a door frame or door body 12 on which are slidably mounted upper and lower panels in the form of windows 14 and 16. Upper and lower retractable screen assemblies 18 and 20 are also mounted on door body 12 and respectively connected to windows 14 and 16. Door body 12 includes a horizontal upper section 22, a horizontal lower section 24, and first and second vertical side sections 26 and 28. A handle 30 is mounted on section 28 and hinges (not shown) are mounted on section 26 to allow door 10 to pivot between open and closed positions. A wiping mechanism 25 (FIGS. 2, 4) is connected to upper section 22 adjacent a lower edge thereof and extends horizontally. Typically, mechanism 25 includes a weather strip with a woven pile projecting outwardly. Likewise, a wiping mechanism 27 (FIGS. 2, 6) having the same configuration is connected to lower section 24 and projects outwardly therefrom.

Referring to FIG. 1A, side section 26 includes a first channel section 32 which extends vertically and includes front and rear vertically extending window-receiving channels 31A and 33A. Likewise, side section 28 includes a second channel section 34 which includes front and rear channels 31B and 33B respectively aligned with channels 31A and 33A. Upper window 14 along its lateral edges is slidably disposed within rear channels 33 of channel sections 32 and 34. Likewise, lower window 16 along its lateral edges is slidably disposed within front channels 31 of channel sections 32 and 34. Rear channels 33 have respective wider sections and narrower sections or screen channels 35A and 35B which extend laterally outwardly beyond the wider sections of channel 33. Rear vertically extending wipers 41 extend inwardly from respective rear walls bounding each screen channel 35. Wipers 41 are typically in the form of a strip of brush-like material or the like. Referring to FIG. 1, upper window 14 includes a window pane 36 and a sash 38 which circumscribes pane 36 and includes upper and lower sections 37 and 39 and spaced side sections extending therebetween. Likewise, lower window 16 includes a window pane 40 with a sash 42 circumscribing pane 40 and including upper and lower sections 44 and 46 and side sections extending therebetween.

Referring to FIG. 2, lower section 39 and upper section 44 in the closed position of windows 14 and 16 overlap and abut one another to substantially prevent air, water, dust and the like from passing through the door. Upper and lower sections 44 and 46 respectively include outwardly projecting handles 48 and 49 to assist in the raising window 16. Upper screen assembly 18 includes a spring-loaded retraction mechanism having a roller 50 on which a screen 52 is windingly mounted. A lower reinforced mounting edge 54 is attached to screen 52 and removably mounted on upper section 37 of sash 38. More particularly, upper section 37 includes a vertically projecting mounting arm 56 to which mounting edge 54 is removably connected by a mounting mechanism 58. Mechanism 58 typically includes a hook and loop fastener or a self-mating reclosable fastener such as sold under the trademark Dual Lock, available from the Minnesota Mining and Manufacturing Company (3M). Other suitable fasteners may be used. Roller 50 and screen 52 are housed within an interior chamber 60 defined by upper section 22 of door body 12. An entrance opening 62 is provided in communication with interior chamber 60 to allow screen 52 to pass therethrough during extension and retraction thereof. Upper section 37 of sash 38 includes a handle 64 to facilitate the lowering and raising of window 14.

With continued reference to FIG. 2, screen assembly 20 includes a spring-loaded retraction mechanism including a rotatable roller 66 on which a screen 68 is windingly mounted to allow extension and retraction thereof. Lower section 24 of door body 12 defines an interior chamber 70 in which roller 66 and screen 68 are housed. An entrance opening 72 to chamber 70 is provided to allow for the extension and retraction of screen 68 therethrough. A reinforced upper mounting edge 74 is attached to screen 68 and is removably connected to a vertically extending rail or wall 76 of lower section 46 by a mounting mechanism 78 having the same characteristics of mounting mechanism 58. Upper and lower sections 22 and 24 of door body 12 respectively include removable covers 80A and 80B which may be removed to allow for the removal and replacement of screen assemblies 18 and 20.

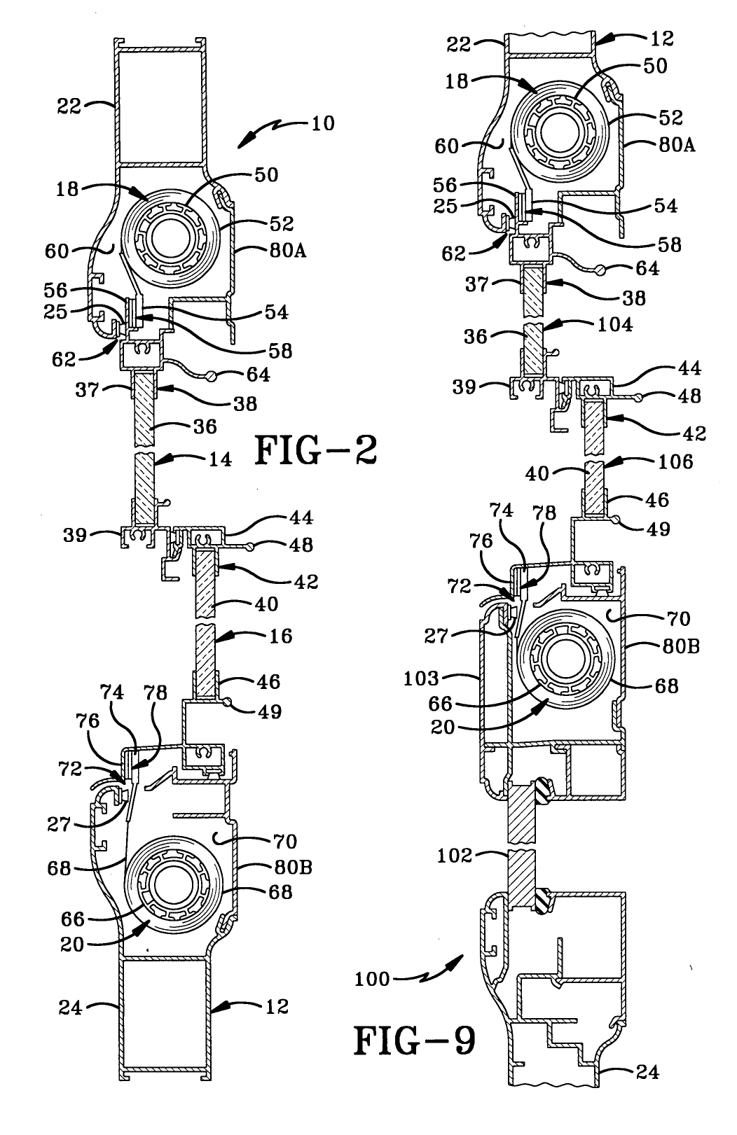

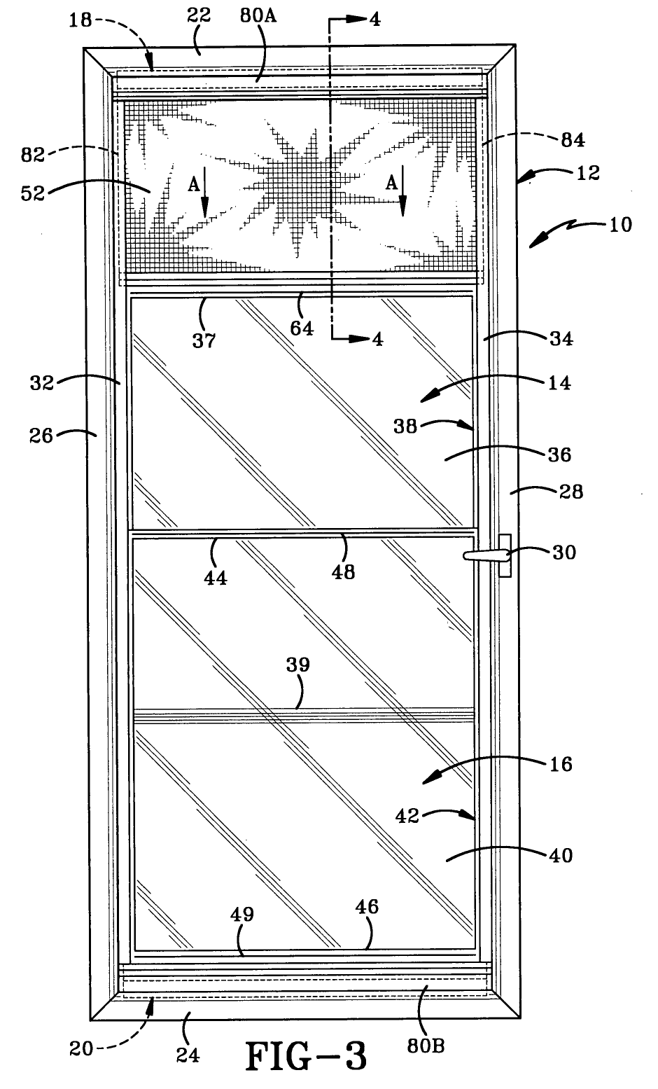

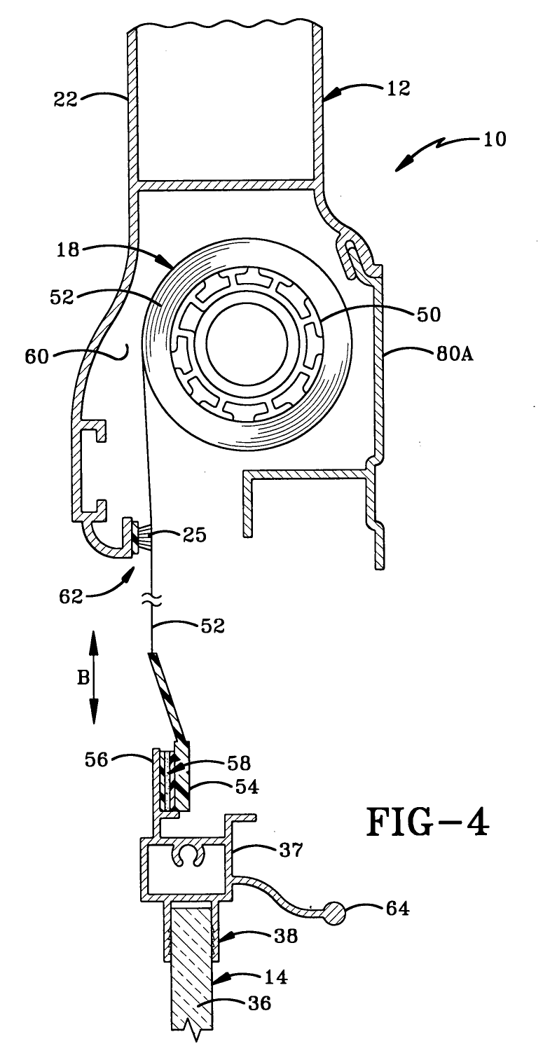

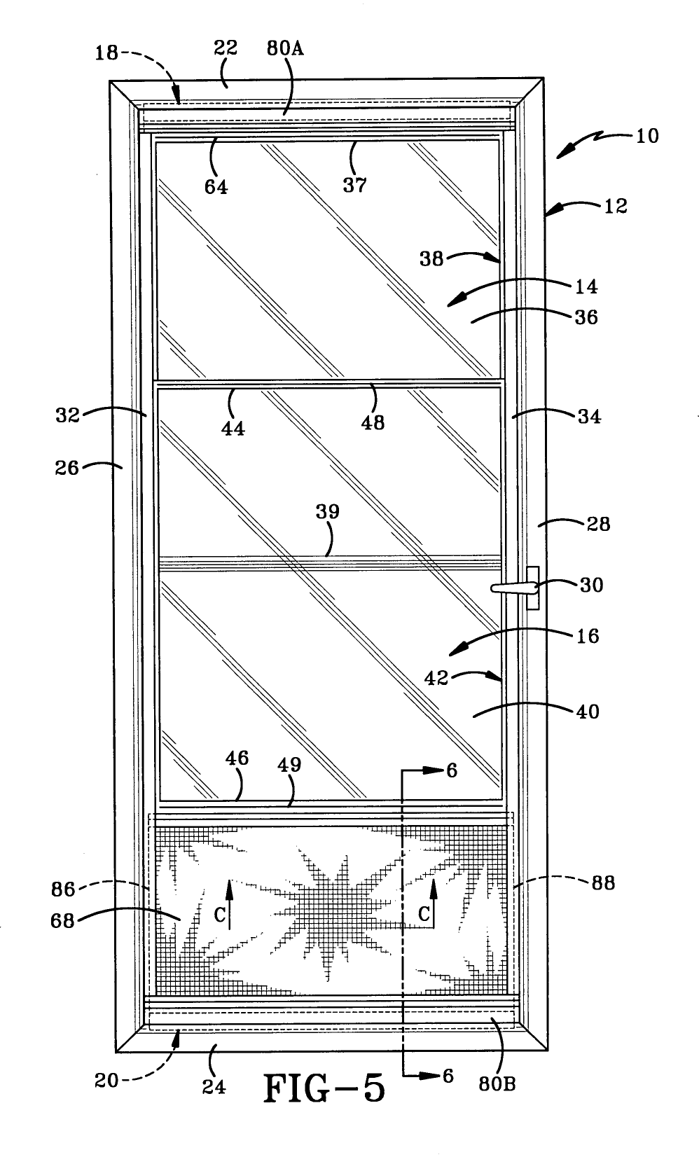

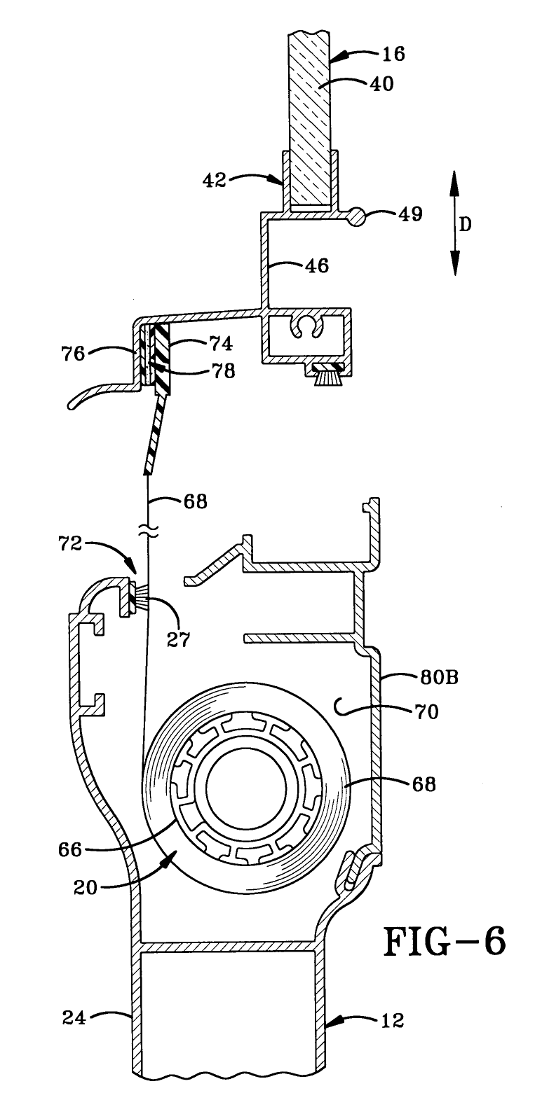

The operation of door 10 is now described with reference to FIGS. 3-7. As shown in FIG. 3, window 14 may be lowered via handle 64 (FIG. 2), thereby unwinding screen 52 against the spring force of the spring-loaded mechanism of assembly 18 so that a portion of screen 52 moves downwardly as indicated at arrows A to cover the opening created by the lowering of window 14. During this extension of screen 52 downwardly, lateral edges 82 and 84 of screen 52 slidably pass through the respective rear window and screen channels 33 and 35 (FIG. 1A) of channel sections 32 and 34. When window 14 is raised, screen 52 is automatically retracted onto roller 50 via the spring-loaded retraction mechanism of assembly 18. The extension and retraction movement of screen 52 is indicated at arrow B in FIG. 4. During this extension and retraction, screen 52 slidably engages wiping mechanism 25, which thus wipes screen 52 to help keep it clean. Mechanism 25 also abuts a portion of upper section 37 when window 14 is raised to provide a weather seal. As shown in FIG. 5, lower window 16 may also be opened by raising and to accordingly pull a portion of screen 68 therewith as indicated at arrows C as screen 68 unwinds from roller 66 (FIG. 2) against the spring force of the spring-loaded retraction mechanism of assembly 20. Screen 68 thus covers the opening created by the raising of window 16. During extension and retraction of screen 68, lateral edges 86 and 88 thereof pass through the forward channels 31 of channel sections 32 and 34. The retraction and extension movement of screen 68 is indicated at arrow D in FIG. 6. During this retraction and extension, screen 68 slidably engages wiping mechanism 27, which wipes screen 68 to help keep it clean in the same manner as wiping mechanism 25. Mechanism 27 also provides a weather seal when window 16 is lowered between lower section 24 of door body 12 and lower section 46 of sash 42 via mounting edge 74. As shown in FIG. 7, each of windows 14 and 16 may thus be opened to create respective upper and lower openings through door 12 which are covered respectively by screens 52 and 68. Thus, door 10 is configured to provide for a plurality of openings which are covered by respective screens to allow for better control of air flow through door 10, which may be enhanced by fans or the like, thus providing for better temperature control.

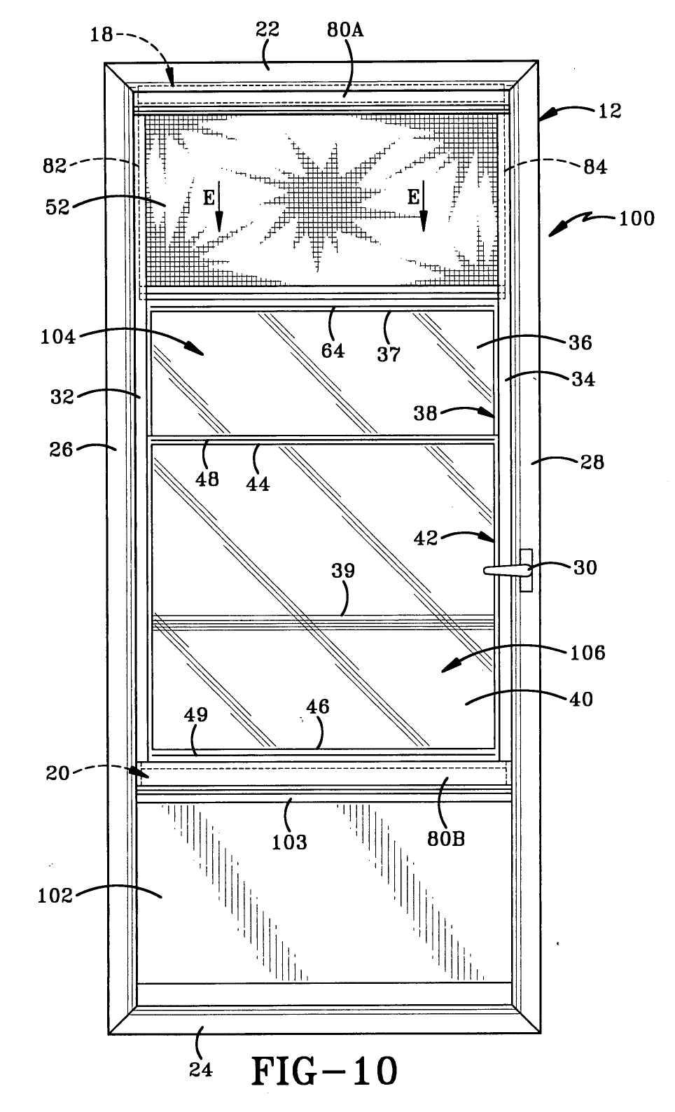

Door 100 is now described with reference to FIGS. 8-12. Door 100 is similar to door 10 except that door 100 includes a kick plate or a preferably rigid lower panel 102 and an intermediate section 103 seated atop lower panel 102 so that the windows of door 100 may be smaller than the windows of door 10 and the lower window is positioned higher than that of door 10. Thus, door 100 includes a door body on which are slidably mounted upper and lower windows 104 and 106 having the same configuration as windows 14 and 16 except for being smaller in size. Thus, window 104 may be lowered as shown in FIG. 10 so that screen 52 is extended as shown at arrows E. Likewise, lower window 106 may be raised as shown in FIG. 11 so that lower screen 68 is extended upwardly as indicated at arrows F. It is noted that a panel similar to panel 102 may be positioned at any height on the door, not just at the bottom.

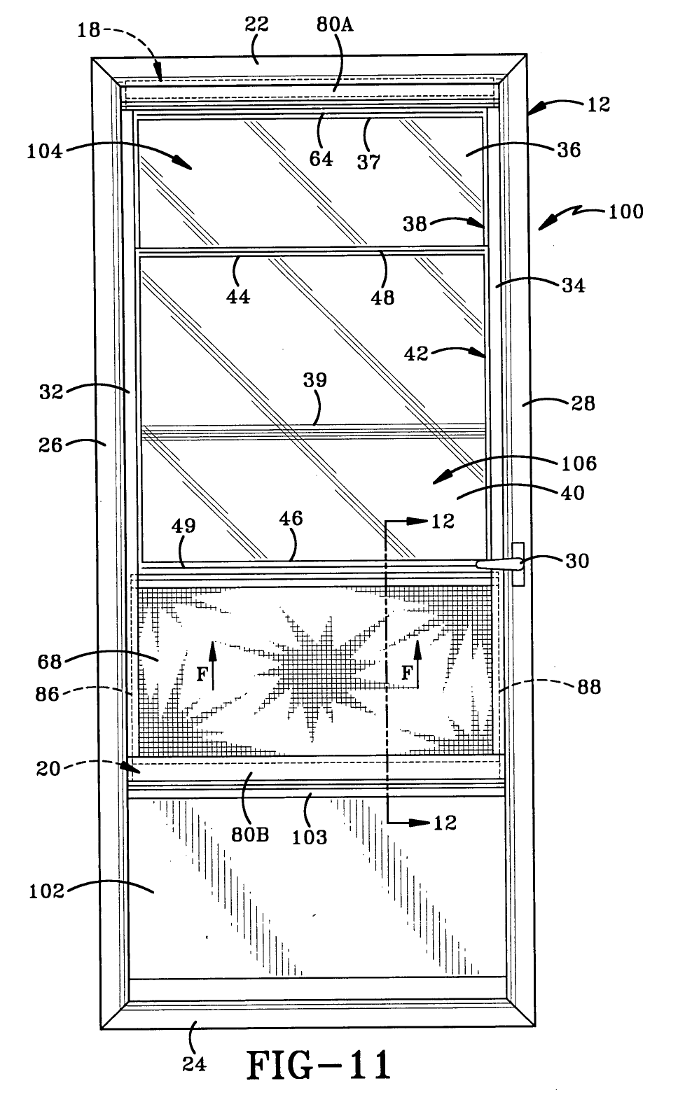

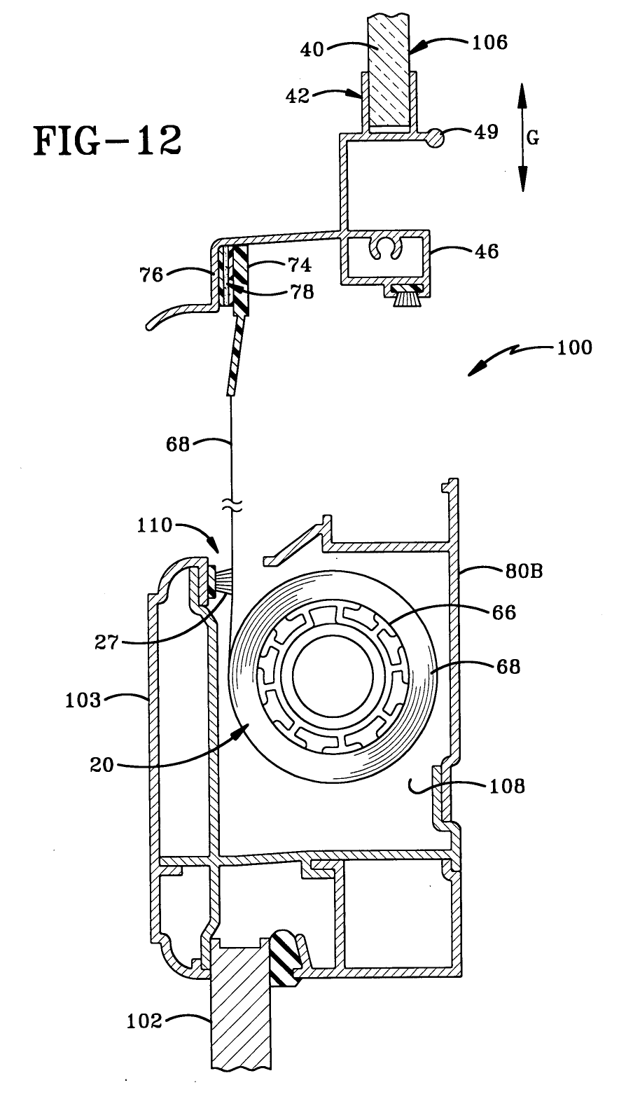

Referring to FIG. 12, the retraction and extension movement of screen 68 are indicated at arrow G. In addition, FIG. 12 shows intermediate section 103 of the door body mounted atop lower panel 102 and defining an interior chamber 108 having an entrance opening 110 through which screen 66 passes during retraction and extension. Windows 104 and 106 of door 100 may be simultaneously opened so that screens 52 and 68 cover respective openings through door 100.

It will be appreciated by one skilled in the art that various changes may be made within the scope of the present invention. While doors 10 and 100 show a pair of windows and a pair retractable screen assemblies, it is within the scope of the present invention to form doors in which there are additional windows and respective retractable screen assemblies. In addition, the windows may be configured to slide laterally or otherwise with respective attached screens moving accordingly.

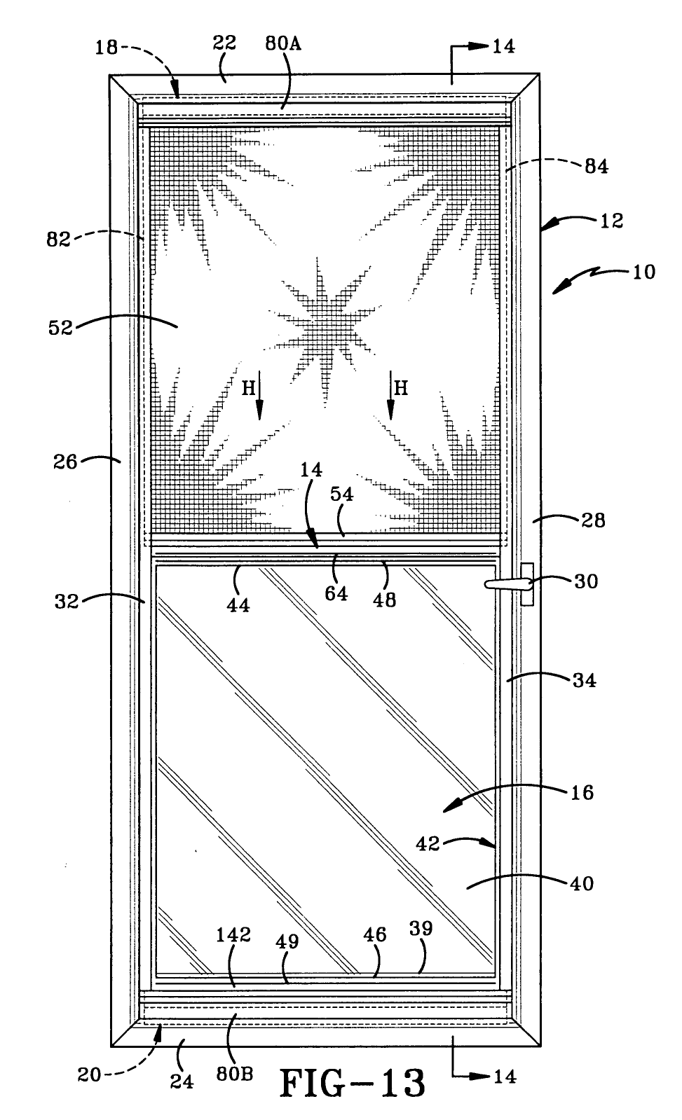

Door 10 and its operation are now described in further detail with reference to FIGS. 13-19. As shown in FIG. 13, window 14 has been slid downwardly as indicated at Arrows H to its fully lowered position with the upper screen 52 unwinding from screen assembly 18 to its fully deployed position. Windows 14 and 16 are thus in their lowermost positions. In accordance with one feature of the invention and with reference to FIG. 14, window 14 has been lowered so that its lower end is seated on a portion of lower section 46 of sash 42 of lower window 16. To facilitate further description, it is noted that upper window 14 has a front side 112 and rear side 114. Likewise, lower window 16 has a front side 116 and rear side 118. In the position shown in FIG. 14, handle 64 of upper window 14 extends forward over upper section 44 of sash 42 of window 16 and is adjacent upper handle 48 of window 16, being spaced upwardly therefrom only a short distance.

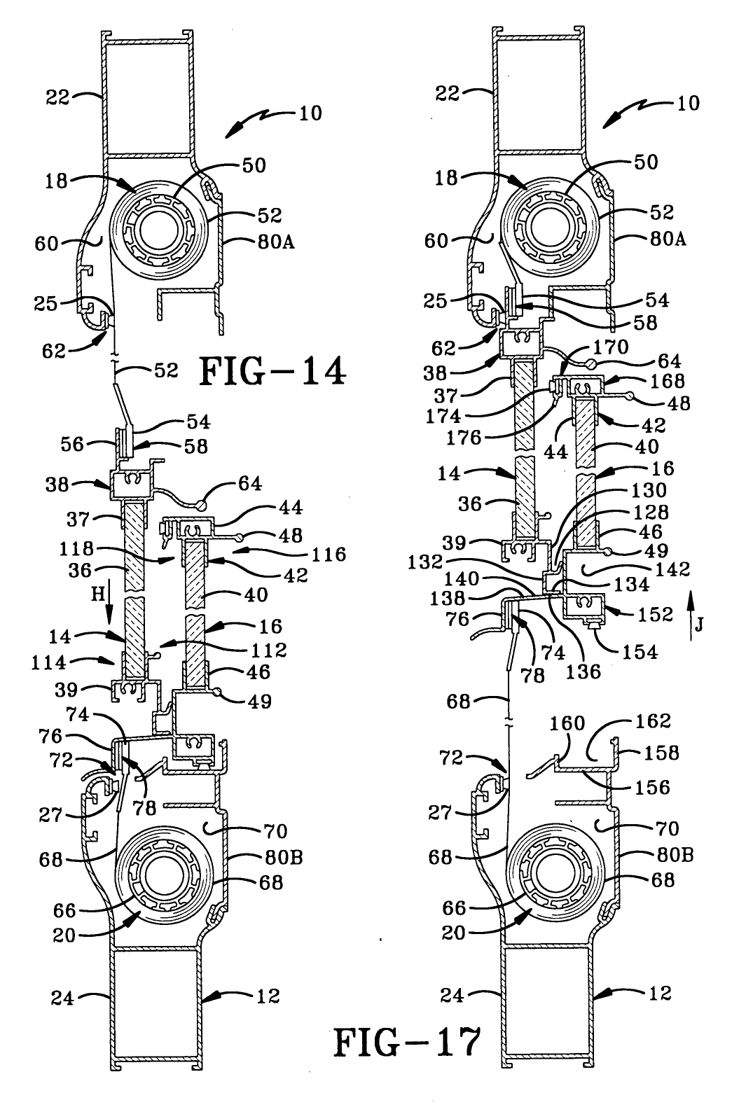

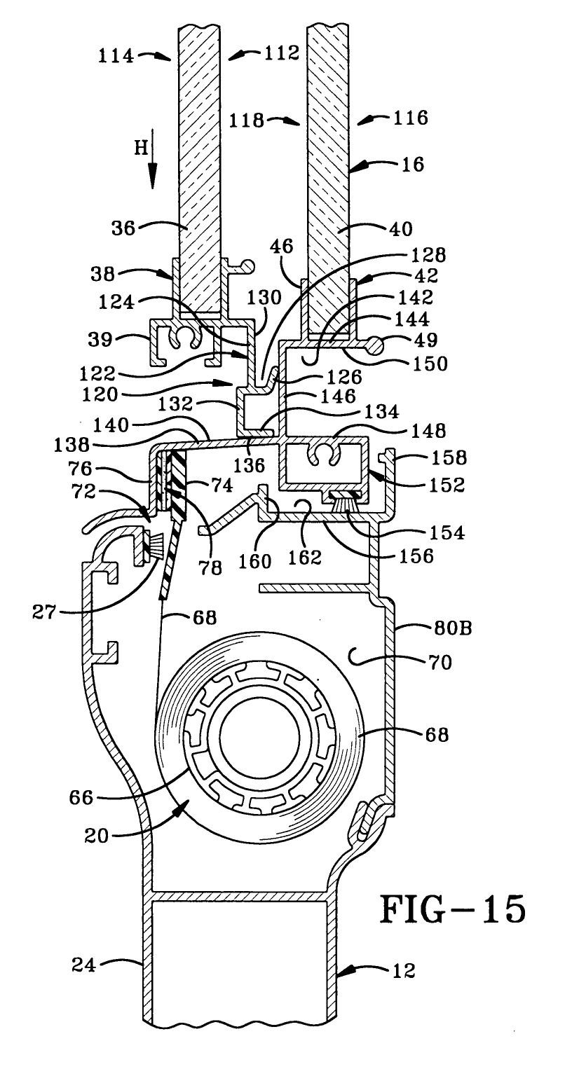

Referring to FIG. 15, lower section 39 of sash 38 includes a projection 120 which extends forward and downwardly from adjacent the lower end of window pane 36 and includes a sealing section 122 comprising a vertical wall 124 and a hook 126 which extends forward and upwardly from the lower end of vertical wall 124 to define therebetween a channel 128. Vertical wall 124 has a vertical forward facing seal-engaging surface 130 which bounds channel 128. Projection 120 further includes a vertical leg 132 which extends downwardly from adjacent the intersection of vertical wall 124 and hook 126. A horizontal foot 134 extends forward from the lower end of leg 132 and has a downwardly facing seating surface 136.

With continued reference to FIG. 15, lower section 46 of sash 42 includes a generally horizontal seating wall 138 having an upwardly facing seating surface 140 on which seating surface 136 is seated to form an interconnection between lower section 39 of sash 38 and upper section 44 of sash 42. Seating wall 138 is connected to the upper end of mounting arm 76 and extends forward therefrom. Thus, the seating engagement between surfaces 136 and 140 is adjacent mounting mechanism 78. An access opening 142 is formed in lower section 46 and extends rearwardly from front side 116 of window 16 directly below window pane 40. Section 46 includes a horizontal wall 144 which extends rearwardly from handle 49, a vertical wall 146 connected to and extending downwardly from the rear of horizontal wall 144 and a lower horizontal wall 148 connected to and extending forward from vertical wall 146 so that each of walls 144, 146 and 148 bound opening 142. Wall 144 includes a downwardly facing surface 150 which bounds opening 142 and serves together with handle 49 as a handle for raising lower window 16. Alternately, the portion of the handle which extends out as shown at handle 49 may be eliminated and lower surface 150 may be used on its own as a handle. Horizontal wall 148 forms part of a hollow rectangular block or structure 152 with a substantially horizontal weather strip comprising a brush-type seal 154 mounted on and extending downwardly therefrom. Various types of weather strips may be used and are typically laterally elongated along the entire length of lower section 46 from adjacent channel section 32 to adjacent channel section 34 (FIG. 13). Cover 80B of lower section 24 of door body 12 has a U-shaped structure at its upper end including a bottom wall 156 with front and rear walls 158 and 160 extending upwardly therefrom to define therebetween an upwardly opening channel 162 which receives a portion of rectangular structure 152 with the upper surface of bottom wall 156 serving as a seating surface engaged by weather strip 154. Roller 66 and screen 68 wound thereon are thus disposed adjacent and below the U-shaped structure defined in channel 162 and each of lower sections 39 and 46 including the seating walls 134 and 138 thereof. When rectangular structure 152 is received within channel 162, the upper terminal end of front wall 158 extends upwardly of the lower end of structure 152. Thus, access opening 142 and surface 150 are disposed sufficiently upward of the upper end of wall 158 to allow manual access to opening 142. Hook 126 is closely adjacent or abuts vertical wall 146 when foot 134 is seated on seating wall 138.

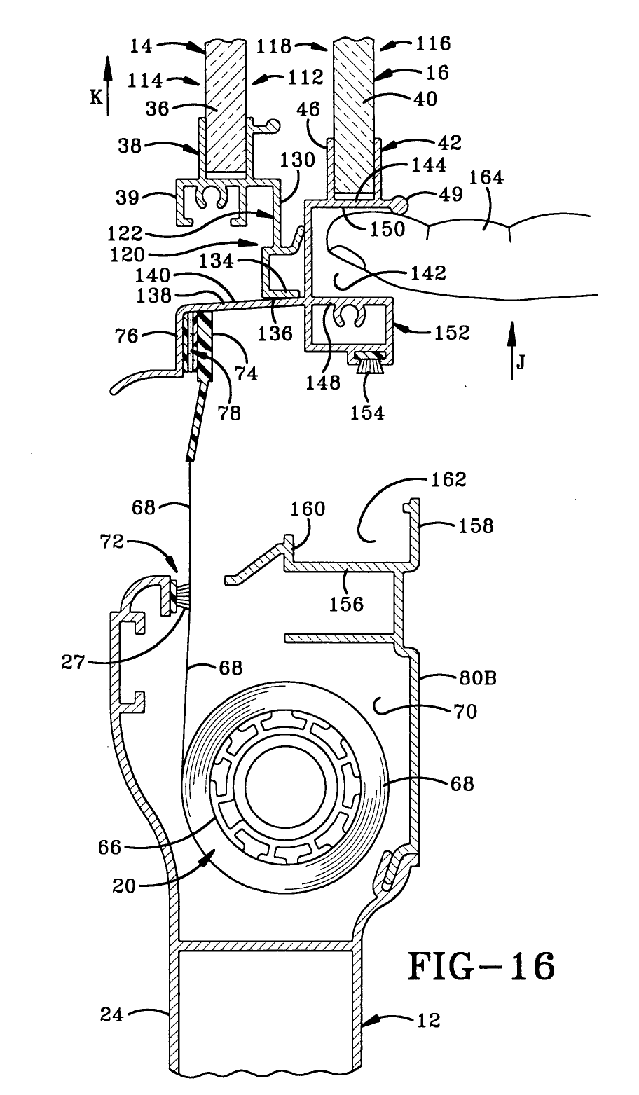

Referring to FIG. 16, access opening 142 provides manual access by one or more fingers 164 so that a tip of a finger is engagable with the lower side of handle 49 and surface 150. The user of door 10 may then manually raise window 16 as indicated at Arrow J in FIG. 16 while simultaneously deploying screen 68 and raising window 14 (Arrow K) via the engagement between foot 134 and seating wall 138. The lifting force provided by finger 164 is thus translated via this seating engagement to window 14. As shown in FIG. 17, the relationship between windows 14 and 16 remains the same as that shown in FIG. 14 throughout the lifting process until both windows are at their fully raised positions. During the lifting process, upper screen 52 is fully retracted onto roller 50 and lower screen 68 is fully deployed from roller 66. FIG. 18 illustrates upper window 14 remaining in the fully raised position while lower window 16 is lowered (Arrow L) to its fully lowered position to provide an interconnection between lower section 39 of sash 38 and upper section 44 of sash 42. It will be appreciated that while FIG. 14 shows both windows in the fully lowered position, FIG. 17 shows the two windows in the fully raised position and FIG. 18 shows one window fully raised and one window fully lowered, each of windows 14 and 16 may be positioned at any height in between these raised and lowered positions and will remain in place as a result of frictional engagement within the channel sections 32 and 34 (FIG. 13).

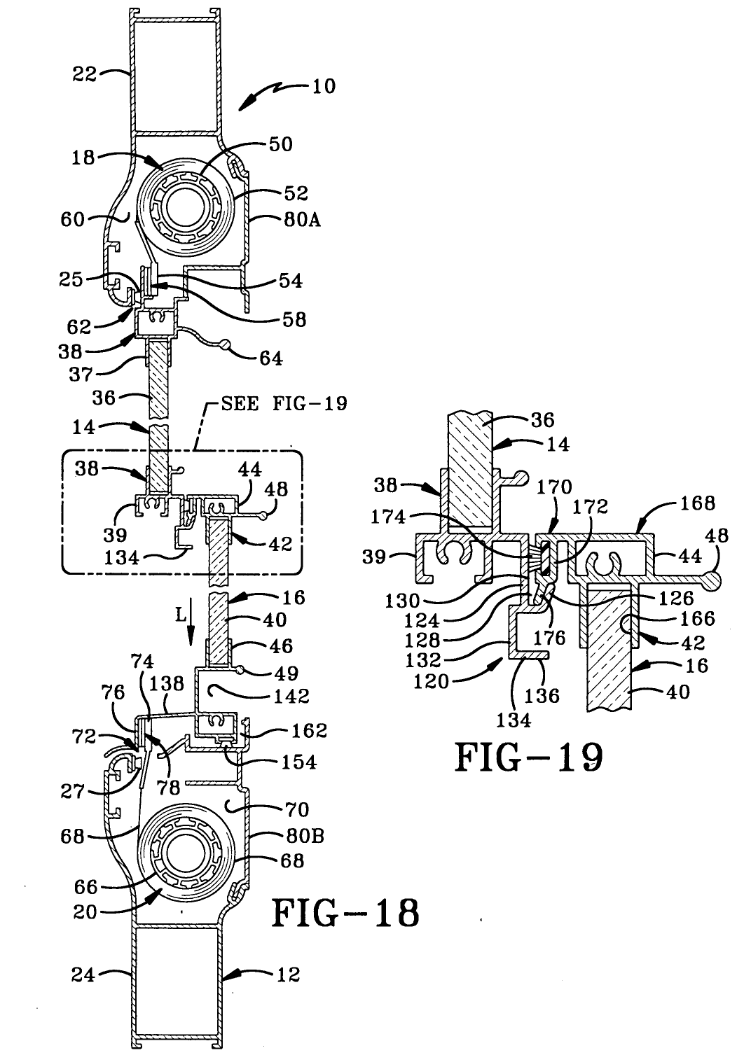

FIG. 19 shows an enlarged view of the interconnection between lower section 39 of sash 38 and upper section 44 of sash 42, which is now described in greater detail. Window pane 40 at its upper end is received in a downwardly opening channel 166 of an inverted U-shaped structure of section 44. Directly above channel 166, channel 44 includes a hollow rectangular block 168 with handle 48 extending forward therefrom at the lower end of block 168. Projection 170 extends rearwardly and downwardly from the upper end of block 168 opposite handle 48. Projection 170 includes a weather strip or seal mount 172 which defines a channel for receiving and mounting thereon a weather strip or seal 174. Weather strip 174 is typically horizontal and extends the entire length of upper section 44. A finger 176 angles downwardly and rearwardly from the bottom of seal mount 172 in a cantilever fashion. When window 14 is fully raised and window 16 is fully lowered, finger 176 is received in channel 128 and matingly engages the upwardly angled portion of hook 126 while the brush-like seal 174 abuts seal-engaging surface 130. These two engagement interfaces generally provide an air flow seal. That is, they generally prevent air from flowing through this region from one side of the window panes to the other although this is most typically not an airtight seal.

Door 10 thus provides two panels or windows which may be manually raised by a single handle on the lower window via a seating engagement or other interconnection at the lower ends of the two windows. This is particularly helpful for people who are not tall enough to reach the upper end of the upper window in order to access a handle such as handle 64 in order to fully raise the upper window. Door 10 thus allows for the raising of the upper window via handle 49 by someone who is able to reach approximately half way up door 10, which is where handle 49 and surface 150 are located in the fully raised positions of windows 14 and 16. In addition, when upper window 14 is in a raised position, weatherstrip 25 abuts a vertical wall of upper section 37 of sash 38 (FIG. 18) to provide an air flow seal in that region of door 10. Likewise, when lower window 16 is in its lowered position weather strip 154 engages bottom wall 156 to provide a similar air flow seal in that region of door 10.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A door assembly comprising:
a door body;
an upper panel mounted on and slidable upwardly and downwardly relative to the door body;
a lower panel mounted on and slidable upwardly and downwardly relative to the door body; and
an interconnection between the upper and lower panels so that the upper panel is upwardly slidable in response to upward sliding movement of the lower panel.

2. The door assembly of claim 1 further comprising a first engaging surface on the upper; a second engaging surface on the lower panel engagable with the first engaging surface to form the interconnection; and a first handle on the lower panel adjacent the second engaging surface.

3. The door assembly of claim 2 further comprising first and second opposed sides on the lower panel; and wherein the first handle is manually accessible from the first side; and the interconnection extends along the second side.

4. The door assembly of claim 1 further comprising a first sash on the upper panel; a second sash on the lower panel; a first engaging surface on the first sash; and a second engaging surface on the second sash engagable with the first engaging surface to form the interconnection.

5. The door assembly of claim 4 wherein the lower panel has upper and lower ends; and further comprising a laterally elongated weather strip on one of the second sash and the door body engagable with the other of the second sash and door body along the lower end of the lower panel.

6. The door assembly of claim 1 further comprising a first sash on the upper panel comprising upper and lower sections; a second sash on the lower panel comprising upper and lower sections; and wherein the upper and lower panels have respective raised and lowered positions; the lower section of the first sash is seated on the lower section of the second sash when the upper and lower panels are in the respective lowered positions; and the lower section of the first sash engages the upper section of the second sash when the upper panel is in its raised position and the lower panel is in its lowered position.

7. The door assembly of claim 6 further comprising a laterally elongated weather strip on one of the lower section of the first sash and upper section of the second sash engagable with the other of the lower section of the first sash and upper section of the second sash when the upper panel is in its raised position and the lower panel is in its lowered position.

8. The door assembly of claim 1 further comprising first and second vertically spaced handles on the lower panel.

9. The door assembly of claim 8 wherein the lower panel has upper and lower ends; and the first and second handles are respectively adjacent the upper and lower ends.

10. The door assembly of claim 9 further comprising a window pane on the lower panel; and a sash comprising upper and lower sections connected to the window pane; and wherein the first handle is on the upper section; and the second handle is on the lower section.

11. The door assembly of claim 9 wherein the lower panel is slidable between a raised position and a lowered position in which its lower end is seated on the door body; and the second handle is spaced upwardly of the lower end.

12. The door assembly of claim 11 further comprising a laterally extending wall on the door body; an upwardly extending wall which is connected to and extends upwardly from the laterally extending wall; and a terminal upper end on the upwardly extending wall; and wherein the lower end of the lower panel is seated on the laterally extending wall in the lowered position; and the second handle is higher than the terminal upper end of the upwardly extending wall in the lowered position.

13. The door assembly of claim 12 further comprising a roller rotatably mounted on the door body below the laterally extending wall and adapted for windingly mounting a screen thereon.

14. The door assembly of claim 13 further comprising a retractable screen windingly mounted on the roller and connected to the lower panel adjacent its lower end.

15. The door assembly of claim 1 further comprising upper and lower ends on the lower panel; and a first handle on the lower panel adjacent its lower end.

16. The door assembly of claim 15 further comprising first and second opposed sides on the lower panel; and an opening formed in the panel adjacent its lower end extending inwardly from the first side toward the second side; and a downwardly facing manually accessible surface bounding the opening and forming at least a portion of the first handle.

17. The door assembly of claim 15 further comprising upper and lower ends on the upper panel; and a second handle on the upper panel adjacent its upper end.

18. The door assembly of claim 17 wherein the second handle extends over the upper end of the lower panel.

19. The door assembly of claim 1 further comprising a first retractable screen mounted on the door body and connected to the first panel; and a second retractable screen mounted on the door body and connected to the second panel.

20. The door assembly of claim 1 further comprising upper and lower ends on the upper panel; and upper and lower ends on the lower panel; and wherein the upper and lower panels have respective raised and lowered positions; and the upper panel adjacent its lower end abuts the lower panel adjacent its upper end when the upper panel is in its raised position and the lower panel is in its lowered position.

21. The door assembly of claim 1 wherein the interconnection is a one-way interconnection so that the upper panel is not downwardly slidable in response to downward sliding movement of the lower panel.
